(19) United States
(12) Patent Application Publication
(10) Pub. No.: US 2007/0024246 A1
(43) Pub. Date: Feb. 1, 2007

(54) Battery Chargers and Methods for Extended Battery Life

(76) Inventor: David J. Flaugher, Raleigh, NC (US)

Correspondence Address: SUTHERLAND ASBILL & BRENNAN LLP, 999 PEACHTREE STREET, N.E., ATLANTA, GA, 30309, US

(21) Appl. No.: 11/460,521

(22) Filed: Jul. 27, 2006

Related U.S. Application Data
(60) Provisional application No. 60/702,692, filed on Jul. 27, 2005.

(51) Int. Cl. H02J 7/04

(52) U.S. Cl. 320/150

(57) ABSTRACT

A battery charger that includes a relay, a control unit, and a temperature sensor. The relay controls the flow of an electrical charge current from a power supply to one or more batteries. The temperature sensor continuously measures the ambient temperature of the one or more batteries and communicates the temperature measurements to the control unit. The control unit control the actuation of the relay. The control unit receives the temperature measurements from the temperature sensor, determines a charging time period for the one or more batteries, and selectively actuates the relay for the charging time period. The charging time period has a predetermined duration and represents a coolest time period within a monitoring period of the control unit.

### CROSS REFERENCE TO RELATED APPLICATIONS

This Application claims priority from U.S. Provisional Application No. 60/702,692, entitled BATTERY STRING CHARGER AND METHOD FOR EXTENDED BATTERY LIFE, which was filed on Jul. 27, 2005, and is incorporated herein by reference.

### FIELD OF THE INVENTION

The present invention relates generally to rechargeable storage batteries, and more specifically to battery chargers used in conjunction with rechargeable storage batteries.

### BACKGROUND OF THE INVENTION

Many electronic applications such as, for example, telecommunications remote sites, utility switchgear sites, wireless sites and railroad sites, typically have a battery back up for electronic equipment in the event of a utility power failure. In many electronic applications, chemical batteries that create electricity from chemical reactions such as, for example, valve regulated lead acid (VRLA) batteries, are used as a battery back up. One advantage of chemical batteries is that they can be charged and their chemical process reversed by forcing electricity through the batteries. VRLA batteries typically die for several reasons, two of which are positive grid growth and electrolyte dry out. Both positive grid growth and electrolyte dry out naturally occur as a result of charging the VRLA batteries.

Float charging is typically used for backup and emergency power applications where the discharge of the battery is infrequent. During float charging, a charger, battery, and load are typically connected. The charger operates off the normal power supply which provides current to the load (e.g., electronic equipment) during operation. In the event of normal power supply failure, the battery provides backup power until the normal power supply is restored.

Float chargers are typically constant-voltage chargers that operate at a low voltage. Operating the charger at a low voltage keeps the charging current low, thus minimizing the damaging effects of high-current overcharging. If the charge voltage is temperature compensated for the battery being charged, the charging current will equal the self discharge rate of the battery, thereby minimizing electrolyte dry out and positive grid growth.

Heat is a catalyst in battery reactions, causing faster electrolyte dry out and faster positive grid growth. Temperature compensating float charges attempt to keep the float charge applied to a battery at a minimum by decreasing the voltage as the battery temperature increases. Typically, as battery temperature increases, the charge voltage is decreased by an average value that the battery manufacturer has determined will on average minimize the float charge. The charge voltage is typically decreased by 0.003 to 0.005 volts per battery cell per degree Celsius that temperature rises above 25° Celsius. As the batteries wear out, the required compensation needed to give the best charge rate for the battery changes.

Temperature compensated battery charges typically use temperature probes to monitor the temperature of the batteries. These temperature probes, however, are often very inexpensive and fragile, causing them to break or wear out without warning. Furthermore, the temperature probes are often placed in areas that are remote to the batteries, such as outside of the enclosure used to house the batteries. For these and other reasons, the temperature compensated charging may fail and, therefore, temperature compensated charging is often not the preferred charging method for charging backup batteries.

Accordingly, there exist a need in the art for an improved battery charger that addresses the shortcomings of temperature compensated battery chargers.

### SUMMARY OF THE INVENTION

According to one embodiment of the invention, there is disclosed an improved battery charger. The battery charger includes a relay that controls the flow of an electrical charge current from a power supply to one or more batteries, a control unit that controls the actuation of the relay, and a temperature sensor that continuously measures the ambient temperature of the one or more batteries. The temperature sensor communicates the temperature measurements to the control unit and, based on the temperature measurements, the control unit determines a charging time period for the one or more batteries and charges the batteries by selectively actuates the relay for the charging time period. The charging time period has a predetermined duration that represents a coolest time period occurring within a monitoring time period of the control unit.

According to another embodiment of the present invention, there is disclosed an automatic system for float charging one or more batteries. The system includes a power supply, a relay, a temperature sensor, and a control unit. The power supply is configured to output an electrical charge current that is used to charge the one or more batteries. The relay controls the flow of the electrical charge current from the power supply to the one or more batteries and the temperature sensor continuously monitors the ambient temperature of the one or more batteries. The control unit receives the temperature measurements from the temperature senor, determines a time period for charging the one or more batteries based on the received temperature measurements, and selectively actuates the relay for the time period for charging the one or more batteries. Additionally, the time period for charging has a predetermined duration and it represents a coolest time period occurring within a monitoring period of the control unit.

According to another embodiment of the present invention, there is disclosed a method for float charging one or more batteries. The ambient temperature of the one or more batteries is monitored over a first monitoring period. Based on the ambient temperature, a charging period for the one or more batteries is determines. The charging period has a predetermined charging duration that represents a coolest time period having the predetermined charging duration that occurs within the first monitoring period. The batteries are then charged during the determined charging period in a second or subsequent monitoring period.

Aspects of the invention described below apply to all of the battery charging, the system for float charging one or more batteries, and the method for float charging one or more batteries. According to one aspect of the present invention, the monitoring period is a twenty-four hour period of time. According to another aspect of the present invention, the charging time period or the time period for charging the one or more batteries is approximately eight hours or less. According to yet another aspect of the present invention, the charging time period occurs at night.

According to another aspect of the present invention, the charging time period is determined for a first monitoring period and, based on the determined charging time period, the batteries are charged during a second monitoring period. According to yet another aspect of the present invention, the charging time period is determined by calculating a running average of the ambient temperature over the first monitoring and determining a lowest temperature period occurring within the first monitoring period that has a lowest average ambient temperature over the duration of the lowest temperature time period. The duration of the lowest temperature time period is the same as the duration of the charging time period.

According to yet another aspect of the present invention, the one or more batteries comprise multiple strings of batteries and the multiple strings of batteries are charged in a rotations order.

According to another aspect of the present invention, the current of the electrical charge being supplied to the one or more batteries is measured. If the current is below a current set point, the one or more batteries will not be charged or, if the batteries are currently being charged, the charging will be stopped. For the embodiments relating to a battery charger and a system for float charging batteries, the current is measured by a current sensor and then communicated to the control unit.

According to yet another aspect of the present invention, the current set point is approximately 0.003 multiplied by a 20 hour rated capacity for the one or more batteries.

According to yet another aspect of the present invention, the battery charger may be incorporated into a power line or power cable that is disposed between the power supply and the one or more batteries. The power line or power cable may be configured to delivery the electrical charge current to the one or more batteries.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of a battery charger according to an illustrative embodiment of the present invention.

FIG. 2 is a block diagram of a control unit that may be associated with a battery charger according to the present invention.

FIG. 3 is an exemplary flowchart of the general operation of the control unit of a battery charger, according to an illustrative embodiment of the present invention.

FIG. 4 is an exemplary flowchart of voltage monitoring performed by a battery charger, according to an illustrative embodiment of one aspect of the present invention.

FIG. 5 is an exemplary flowchart of ambient temperature monitoring performed by a battery charger, according to an illustrative embodiment of one aspect of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Aspects of the present invention are described below with reference to block diagrams of systems, methods, apparatuses and computer program products according to an embodiment of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams support combinations of means for performing the specified functions, combinations of steps for performing the specified functions and program instruction means for performing the specified functions. It will also be understood that each block of the block diagrams, and combinations of blocks in the block diagrams, can be implemented by special purpose hardware-based computer systems that perform the specified functions or steps, or combinations of special purpose hardware and computer instructions.

The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc.

Application programs that are components of the invention may include routines, programs, components, data structures, etc. that implement certain abstract data types, perform certain tasks, actions, or tasks. In a distributed computing environment, the application program (in whole or in par) may be located in local memory, or in other storage. In addition, or in the alternative, the application program (in whole or in part) may be located in remote memory or in storage to allow for the practice of the inventions where tasks are performed by remote processing devices linked through a communications network. Exemplary embodiments of the present invention will hereinafter be described with reference to the figures, in which like numerals indicate like elements throughout the several drawings.

According to one embodiment of the present invention, disclosed is a battery charger and method for extending battery life in which one or more batteries may be charged for a limited time each day, but positive grid growth and electrolyte dry out of the one or more batteries is limited. According to an aspect of the present invention, one or more batteries may be charged during the coolest or lowest temperature time period of a day, thereby limiting grid growth and dry out and extending battery life. The battery charger of the present invention may monitor the ambient temperature around the one or more batteries during a 24 hour period of time and charge the one or more batteries for a predetermined length of time that is likely the coolest period of time of the predetermined length occurring during the 24 hour period.

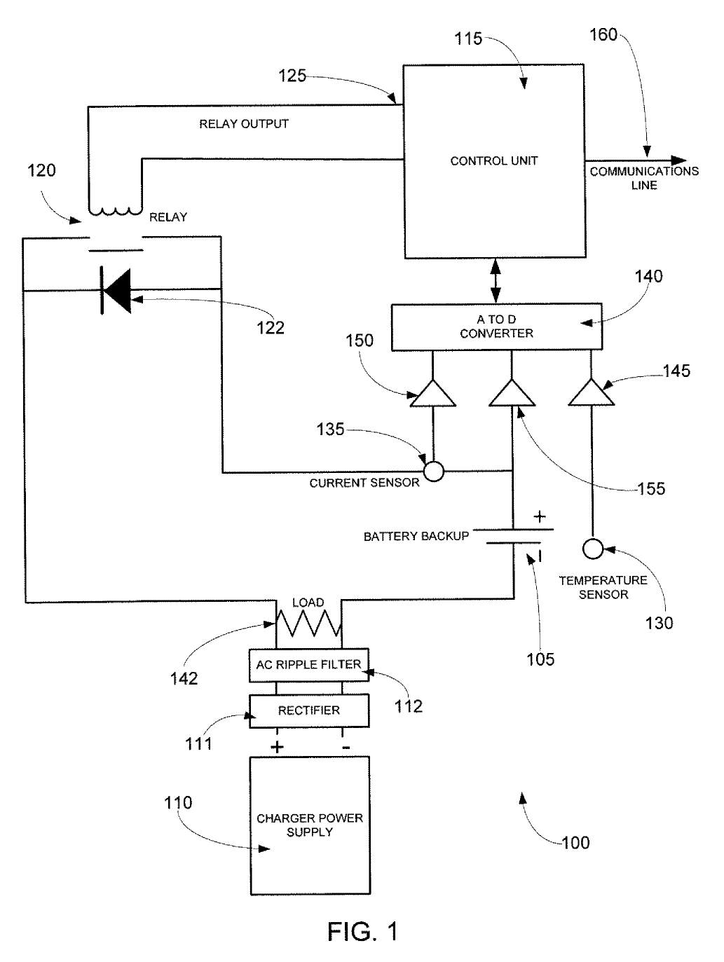

FIG. 1 is a schematic diagram of a battery charger 100 that may be used to charge one or more batteries 105 according to an illustrative embodiment of the present invention. The battery charger 100 may include a charger power supply 110, a rectifier 111, an AC ripple filter 112, a control unit 115, a relay 120, a blocking diode 122, a relay output 125, a temperature sensor 130, a current sensor 135, and an analog-to-digital converter 140.

The one or more batteries 105, herein referred to as batteries, that are charged by the battery charger 100 may be backup batteries used in conjunction with electronic equipment such as the equipment present at a telecommunications remote site. The batteries 105 may also be chemical batteries such as, for example, valve regulated lead acid (VRLA) batteries. The batteries 105 may be used to power a load 142 (e.g., electronic equipment) in the event of a power outage or failure. In the event that the batteries are discharged to power a load, thereby causing the charge level of the batteries to decrease, the battery charger 100 may charge the batteries 105 to their correct level of charge. Additionally, the battery charger 100 may float charge the batteries 105 each day for a predetermined period of time to maintain a correct level of charge in the batteries 105.

It will be understood that the one or more batteries 105 may form one or more strings of batteries. If multiple strings of batteries are present, the battery charger 100 of the present invention may be used to charge each of the strings of batteries 105 in a rotational order.

The charger power supply 110 may be used by the battery charger 100 to charge the batteries 105. The charger power supply 110 may be an alternating current (AC) source that generates an AC signal. The charger power supply 110 may be any alternating current source such as, for example, the alternating current source used to provide primary power to the load 142. The charger power supply 110 may be a power line that is used to provide power to the electronic equipment that makes up the load 142.

The AC signal provided by the charger power supply 110 may be passed through a rectifier 111 that receives the alternating current (AC) signal and converts it to a direct current (DC) signal that is then outputted by the rectifier 111. The rectifier 111 may provide half wave rectification such that the outputted signal has a non-zero DC value; however, it will be understood by those of skill in the art that full wave rectification may be used in accordance with the present invention.

The output of the rectifier 111 may be passed through an AC ripple filter 112 in order to prevent any alternating current signal or AC ripple from reaching the batteries 105, because such an occurrence may serve to decrease the life span of the batteries 105. The AC ripple filter 112 may be a standard resistor-inductor-capacitor (RLC) circuit that smooths out or eliminates an AC ripple voltage that passes through the rectifier 111.

The DC output of the rectifier 111 may be used to charge the batteries 105 connected to the battery charger 100. A relay 120 may control the flow of the DC signal from the rectifier 111 to the batteries 105. The relay may be, for example, a single pole single throw (SPST) relay; however, it will be understood by those of skill in the art that one or more of a multitude of relays may be used in accordance with the present invention. If the relay 120 of the battery charger 100 is in a closed position, then the DC signal that is output by the rectifier 111 may be used to charge or float charge the batteries 105. If, however, the relay 120 is, in an opened position, then the output of the rectifier 111 will be prevented from charging the batteries 105. The control unit 115 may be configured to monitor the batteries 105 and their environment and to charge the batteries 105 at an appropriate time by closing the relay 120, as explained in greater detail below The control unit 115 may control a relay output 125 or charging switch that is used to close the relay 120. If the control unit 115 drives the relay output 125, then the relay 120 may be closed, thereby allowing the batteries 105 to be charged. If, however, the control unit 115 fails to apply a drive signal to the relay output 125, the relay 120 may be held in its open position, thereby preventing charging of the batteries 105.

Additionally, a blocking diode 122 or solid state switch may be connected in series with the batteries 105 and in parallel with the relay 120. The blocking diode 122 may be configured to prevent a charge signal generated by the charger power supply 110 from reaching the batteries 105 while permitting backup power to be provided to the load 142 by the batteries 105. The blocking diode 120 may be configured so that a charge signal generated by the charger power supply 110 and passed through the rectifier 111 will not be permitted to pass through the blocking diode 120 to reach the batteries 105. The blocking diode 120, however, will permit backup power to be provided to the load by the batteries 105. If the voltage of the signal generated by the charger power supply 110 falls below the voltage in the batteries 105, such as during a power outage, then a current may flow from the batteries 105 through the blocking diode 120 to the load 142. The flow of backup power from the batteries 105 through the blocking diode 122 to the load 142 may occur regardless of the position of the relay 120. In other words, if the voltage of the signal generated by the charger power supply 110 falls below the voltage in the batteries 105, backup power will be provided to the load 142 by the batteries 105 if the relay 120 is in either its closed position or its opened position,

According to an aspect of the present invention, the control unit 115 may monitor the batteries 105 and the battery environment and control the charging of the batteries 105 by selectively opening and closing the relay 120. The control unit 115 may contain one or more microcontrollers and associated components such as resistors, diodes, capacitors, and crystals or, alternatively, the control unit 115 may be any other suitable device and associated circuitry for controlling an electronic circuit including, but not limited to, microprocessors, one or more programmable logic arrays, a state machine, a mini-computer, or a general purpose computer along with any associated firmware and software.

The control unit 115 may monitor various parameters or variables associated with the batteries 105 in determining when to charge the batteries 105. For example, the parameters the control unit 115 may monitor include, but are not limited to, ambient temperature, voltage, current, conductance, resistance, and impedance. Additionally, it will be understood that the control unit 115 may only allow the batteries 105 to be charged when the values of one or more of the various parameters is within a predetermined range.

One or more sensing devices 130, 135 may be used to measure parameters associated with the batteries 105 that are utilized by the control unit 115 in determining when to charge the batteries 105. As shown in FIG. 1, a temperature sensor 130 may be used to measure the ambient temperature of the batteries 105 or the battery environment. The temperature sensor may be a temperature probe, digital thermometer, or any other suitable device for measuring the ambient temperature. Additionally, a current sensor 135 may be used to measure the current flowing into or out of the batteries 105. The current sensor 135 may be a current sensing transistor, a current transducer, a current transformer, an ammeter, or any other suitable device for measuring an electric current. If analog measurements are taken by one or more of the sensing devices 130, 135, then the analog measurements taken by the sensing devices 130, 135 may be provided to or passed through an analog-to-digital converter 140 before being communicated to the control unit 115. Additionally, the voltage present in the batteries 105 may be provided to the analog-to-digital converter 140 and then communicated to the control unit 115 or, alternatively, a digital voltage measurement may be taken by a suitable voltage measuring device and communicated directly to the control unit 115. The voltage may be measured directly by the control unit 115 or, alternatively, a voltage measuring device such as a voltmeter or any other suitable device for measuring voltage may be utilized in accordance with the present invention.

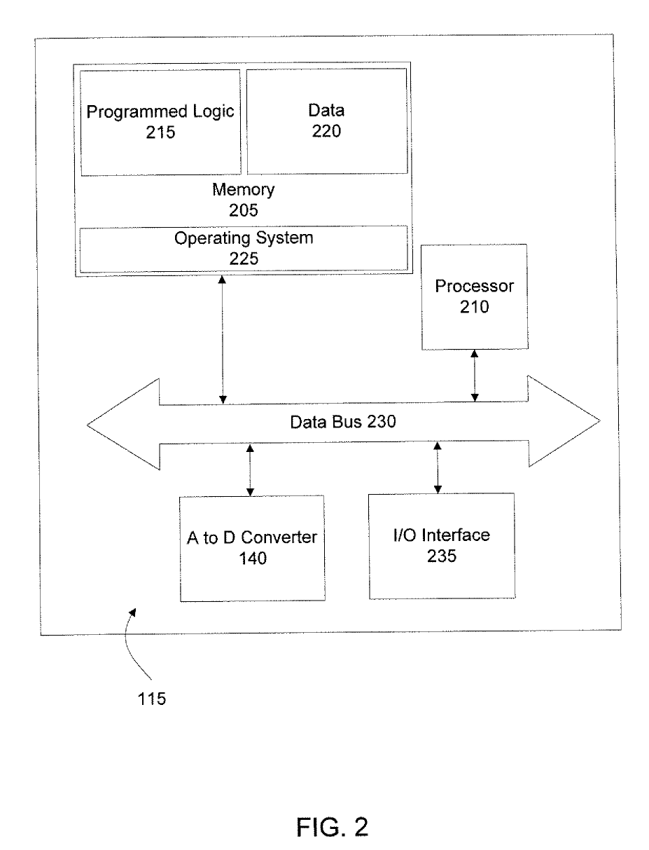

The analog-to-digital converter 140 may be used to convert the analog measurements into digital signals that can be stored and/or manipulated by the control unit 115. As shown in FIG. 1, the analog-to-digital converter 140 is not incorporated into the control unit 115; however, it will be understood by those of skill in the art that the analog-to-digital converter 140 may be integrated into or incorporated into the control unit 115, as explained in greater detail below with reference to FIG. 2.

Additionally, as shown in FIG. 1, the various measurements taken by the sensors 130, 135 and the voltage present in the batteries may be provided to or passed though one or more amplifiers before being communicated to the analog-to-digital converter 140 or, in the case of digital measurements, to the control unit 115. More specifically, a temperature measurement taken by the temperature sensor 130 may be passed through a temperature amplifier 145 before it is communicated to the analog-to-digital converter 140; a current measurement taken by the current sensor 135 may be passed through a current amplifier 150 before it is communicated to the analog-to-digital converter 140; and a voltage signal may be passed through a voltage amplifier 155 before it is communicated to the analog-to-digital converter 140.

As explained in greater detail below, the control unit 115 may take a number of control actions. For example, the control unit 115 may utilize the various measurements to determine an appropriate float charge time for a battery 105 and then cause the battery 105 to be charged by closing the relay 120 for the appropriate float charge time. The control unit 115 may also utilize the various measurements to determine when a battery 105 is nearing the end of its life cycle or life span. If the control unit 115 determines that a battery 105 is nearing the end of its life cycle, then the control unit 115 may take a control action such as, for example, communicating an alarm signal to a user of the battery charger 100 over a communications line 160.

FIG. 2 is a block diagram of a control unit 115 that may be associated with a battery charger 100 according to the present invention. The control unit 115 may include a memory 205 and a processor 210. The memory may store programmed logic 215 (e.g., software code) in accordance with the present invention. The memory 205 may also include measurement data 220 utilized in the operation of the present invention and an operating system 225. The processor 210 utilizes the operating system 225 to execute the programmed logic 215, and in doing so, also utilizes the measurement data 220. The programmed logic 215 may include the logic associated with operation of the battery charger 100. A data bus 230 may provide communication between the memory 205 and the processor 210. The control unit 115 may be in communication with the other components of the battery charger 100 and perhaps other external devices, such as lights, speakers, keyboards, mouse devices, and other user interface devices, via an I/O Interface 235. Additionally, the analog-to-digital converter 140 may be in incorporated into the control unit 115 as opposed to being a separate circuit device as shown in FIG. 1. An I/O Interface 235 enables to control unit to communicate with external devices, such as the temperature sensor 130 and the current sensor 135. Further, the control unit 115 and the programmed logic 215 implemented thereby may comprise software, hardware, firmware or any combination thereof.

The control unit 115 may utilize the various measurements in determining whether or not the batteries 105 will receive a charge or float charge signal from the charger power supply 110. According to an aspect of the present invention, the control unit 115 may limit the charge time of the batteries 105 to a time period of a predetermined length in order to prevent grid growth and dry out, thereby extending battery life. The predetermined length of the time period, hereinafter referred to as the charging time span, may be any length of time established by a user of the present invention such as, for example, a four hour, six hour, or eight hour time period. The batteries 105 may then be float charged for an amount of time not to exceed the charging time span once in a given monitoring time span. The monitoring time span may be any time period in which the batteries 105 are monitored such as, for example, one day or 24 hours.

If the control unit 105 determines that the batteries 105 have been discharged, such as in the event of a power outage, then the control unit 115 may permit the relay 120 to be closed, thereby allowing the batteries to be recharged by the charger power supply 110 for a predetermined continuous period of time that may be, for example, the monitoring time span. If, however, the batteries 105 have not been discharged, then the control unit 115 may permit the relay 120 to be closed for a time period up to or equal to the charging time span. Accordingly, the batteries 105 will be float charged by the charger power supply 110 for only a portion of the monitoring time span. As an example, if the monitoring time span is 24 hours and the batteries 105 have been discharged, then the control unit 105 may cause or permit the batteries 105 to be float charged for up to 24 hours. If, however, the batteries 105 have not been discharged, then the control unit 105 may cause or permit the batteries 105 to be float charged for only a portion of the 24 hour period such as, for example, over an eight hour period of time.

The control unit 115 may utilize the measurements taken by the temperature sensor 130 in determining an appropriate time period in which to charge the batteries 105. According to an aspect of the present invention, the control unit 115 may limit the charging of the batteries 115 to a charging time span. The charging time span may represent the coolest average time period having a duration that is roughly equivalent to the length of the charging time span that occurs during a given monitoring time span. For example, if the charging time span is eight hours and the monitoring time span is 24 hours, the control unit 115 may determine the coolest eight hour time period occurring in a 24 hour period. The control unit 105 may then utilize the determined coolest time period in subsequent float charges of the batteries 105. For example, if the coolest eight hour time period occurring during a 24 hour period is determined to be a time period extending from approximately midnight until approximately eight o'clock in the morning, future float charges of the batteries 105 may be conducted by the control unit 115 during subsequent monitoring time spans between midnight and eight o'clock in the morning. By reducing the float charge period of the batteries 105 to the coolest period of time roughly equivalent to thirty percent of a day, or approximately eight hours, the control unit 115 may extend the life of the batteries 105 while keeping the batteries 105 fully charged,

It will be understood by those of skill in the art that the length of the charging time span may be any length of time occurring within the monitoring time span. In accordance with an aspect of the present invention, the length of the predetermined time period is approximately eight hours or less, but whatever the length of the charging time span, it is preferred that the charging time span is the coolest such period occurring during the monitoring time span. For example, the length of the predetermined time period may be roughly equivalent to fifteen percent of a day, or approximately four hours. If the charge voltage used to float charge the batteries 105 is set to the high side of the batteries' 105 recommended float charge voltage range, then the batteries 105 may be sufficiently charged in a four hour period. Battery life may be preserved by the control unit 115 by ensuring that the four hour period is the coolest four hour period of the day.

The temperature sensor 130 may continuously measure the ambient temperature at or near the batteries 105 and transmit the temperature measurements to the control unit 115. Thus, the control unit 115 may continuously monitor the ambient temperature. The control unit 115 may periodically store or record in memory 205 a data measurement that represents the current ambient temperature such as, for example, once every five minutes. Each time a new data measurement is stored in memory 205, the control unit 115 may determine or calculate the average temperature over the previous charging time span such as, for example, over the previous eight hours. The control unit 115 may then compare the calculated average temperature to a previously stored data value representing the lowest average temperature over a charging time span. The previously stored lowest average temperature is referred to herein as the low temperature average and the time period over which the low temperature average was determined is referred to herein as the low temperature period. If the new determined value of average temperature is lower than the previously stored low temperature average, then the control unit 115 may replace the value of the previously stored low temperature average with the new value. The control unit 115 may also replace the value of the low temperature period with the time period over which the new average temperature was calculated. Accordingly, the control unit 115 may determine the coolest time period of a predetermined length (i.e., charging time span) for a given monitoring time span.

During a subsequent monitoring time span, such as, for example, during the next 24 hour day, the control unit 115 may allow the batteries 105 to be float charged during the determined low temperature period. For example, if the low temperature period is determined to occur between midnight and eight o'clock in the morning, then during a subsequent monitoring time span, the control unit 115 may float charge the batteries 105 between midnight and one o'clock in the morning. In other words, the control unit 115 may initiate the float charging of the batteries 105 at a point in time corresponding to the starting point of the low temperature period and may continuously charge the batteries 105 for a period of time up to the time interval or duration associated with the low temperature period. The control unit 115 may store the starting point of the low temperature period, hereinafter referred to as the charging start point, in its memory 205. Additionally, it will be understood that the control unit 115 may store the value of the low temperature period in memory 205 unit after the batteries 105 have been float charged in a subsequent monitoring time span such as, for example, during the next day. Accordingly, the control unit 115 may maintain the value of the low temperature period in memory 205 while the value of the next low temperature period is being determined.

It will also be understood that the control unit 115 may utilize alternative methods for determining a low temperature period such as for example, historical data, data that is averaged over multiple monitoring time spans, manual settings, or period calibration. As one alternative, historical data such as, for example, historical data relating to average daily temperatures in a particular area or region may be utilized by the control unit 115 in determining a low temperature period in which to float charge the batteries 105. As another alternative for determining a low temperature period for float charging the batteries 105, the control unit 115 may average multiple measured low temperature periods together over the course of multiple monitoring time spans such as, for example, over the course of a week or a month. As another alternative, the low temperature period in which the batteries 105 are to be charged by the control unit 115 may be manually input into the control unit 115 by a user of the present invention. As yet another alternative, if period calibration is utilized by the present invention, the control unit 115 may utilize a determined value of the low temperature period over the courses of more than one subsequent monitoring time span. For example, the control unit 115 may determine the low temperature period once a week and then float charge the batteries each day of the next week during the determined low temperature period.

According to another aspect of the present invention, the control unit 105 may determine an optimum charging for a battery 105 for a particular day by utilizing the measurements taken by the current sensor 135. The optimum charging for the battery 105 may take the aging and temperature effects on the battery into account. The measurements taken by the current sensor 135 may be utilized by the control unit 115 to determine when the current flowing into the battery 105 from the charger power supply 110 is less than a current set point. When the current flowing into the battery 105 is less than a current set point, the control unit 115 may stop or shut off the charging of the battery 105 for the day. It will be understood that many different current set points may be utilized by or established by the control unit 115. Testing has shown that a suitable set point may be, for example, approximately 0.003 multiplied by the 20 hour rated capacity of the battery 105, as established by the manufacturer of the battery 105. As an example, the current set point for a 40 amp hour rated battery would be approximately 120 milliamps, and the control unit 115 would stop the float charging of the battery 105 when the current flowing into the battery 105 fell below 120 milliamps.

The control unit 115 may utilize the measurements taken by the temperature sensor 130 to determine and/or vary the current set point. The set point current may be reduced as the ambient temperature of the battery 105 increases, thereby compensating for the increased efficiency of the hotter batter. [At what rate is the current set point reduced as temperature rises? For example, is it 1 mA for every degree Celsius that temperature rises above 25 degrees Celsius?]

By utilizing a current set point, the float charge time of a battery 105 may be limited by the control unit 115 to a period of time that is less than the predetermined length of time for charging. For example, if the predetermined length of time is eight hours, the charge time may be limited to six hours by the use of a current set point. These six hours may be the coolest six hours of the day.

According to another aspect of the present invention, the control unit 115 may maintain one or more states or flags for each battery 105. Each flag may be held in an on position or in an off position. For example, the control unit 115 may maintain a battery discharge flag for each battery 105 or collectively for all of the batteries that indicates whether or not the batteries 105 have been discharged. If the battery discharge flag is in its on position, then the control unit 115 may cause the batteries 105 to be float charged for a predetermined time period, herein referred to as the recharging time span. The recharging time span may be any predetermined period of time such as, for example, a 24 hour time period. As another example of a flag that may be utilized in accordance with the present invention, the control unit 115 may maintain a battery life flag for each battery 105 that indicates when a battery 105 is nearing the end of its life cycle or life span, as explained in greater detail below.

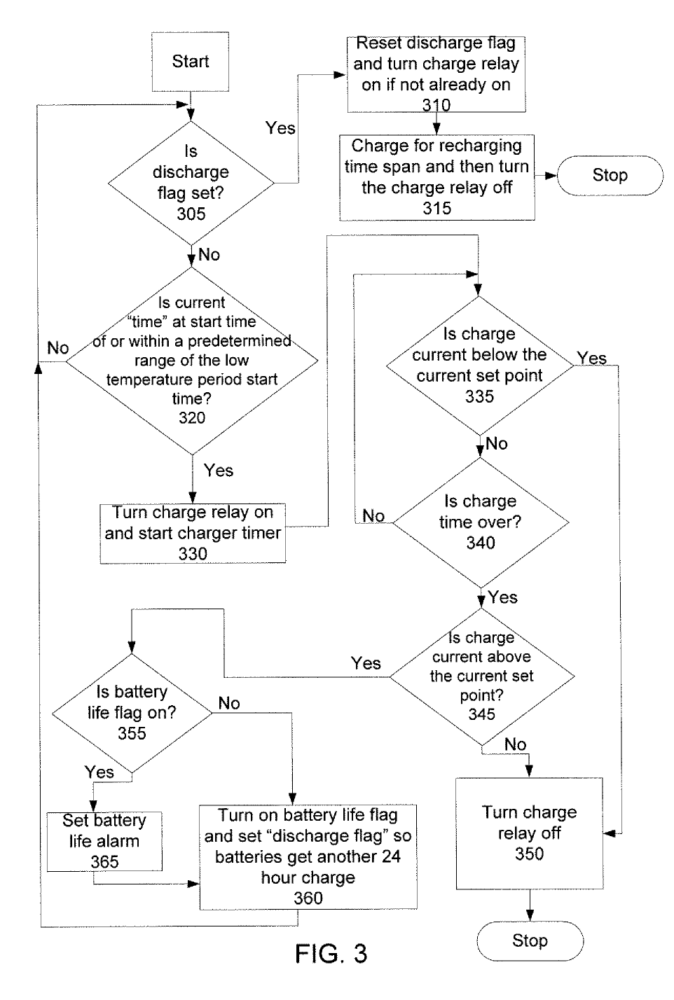

According to another aspect of the present invention, the control unit 115 may utilize the measurements taken by the current sensor 135 to determine whether or not the batteries 105 have been discharged. The control unit 115 may determine that the batteries 105 have been discharged if a current is detected by the current sensor 135 while the relay 120 is in its opened position. For example, if there is a power outage, current may cease to flow from the charger power supply 110 to the load 142. At this time, a current may flow from the batteries 105 through the blocking diode 122 and provide power to the load 142 without the relay 120 being closed. The current flowing from the batteries 105 may be detected by the current sensor 135 and communicated to the control unit 115 and, based on this detected current the control unit 115 may determine that the batteries 105 have been discharged. Once it has been determined that the batteries 105 have been discharged, the control unit 115 may set the discharge flag associated with batteries 105. The discharge flag, which may be stored in the memory 205 of the control unit 115, may then be utilized by the control unit 115 in determining whether or not the batteries 105 should be float charged for a recharging time span, as described in greater detail below with reference to FIG. 3.

According to another aspect of the present invention, the control unit 115 may determine when a battery 105 being serviced by the battery charger 100 is nearing the end of its life cycle or life span. If, after a float charge has been applied to a battery 105 for a predetermined period of time and the charge current is still above the current set point, then the control unit 115 may determine that the battery 105 is nearing the end of its useful life. If the battery life flag has not been set to an on position, then the control unit 115 may toggle the battery life flag to an on position and set the battery discharge flag to an on position, thereby causing the battery 105 to receive an additional charge for the recharging time span. If the battery life flag has already been set to an on position, then the control unit 115 may set a battery life alarm and then set the battery discharge flag to an on position. The battery life alarm may then be communicated to a user by the control unit 115 over the communications line 160.

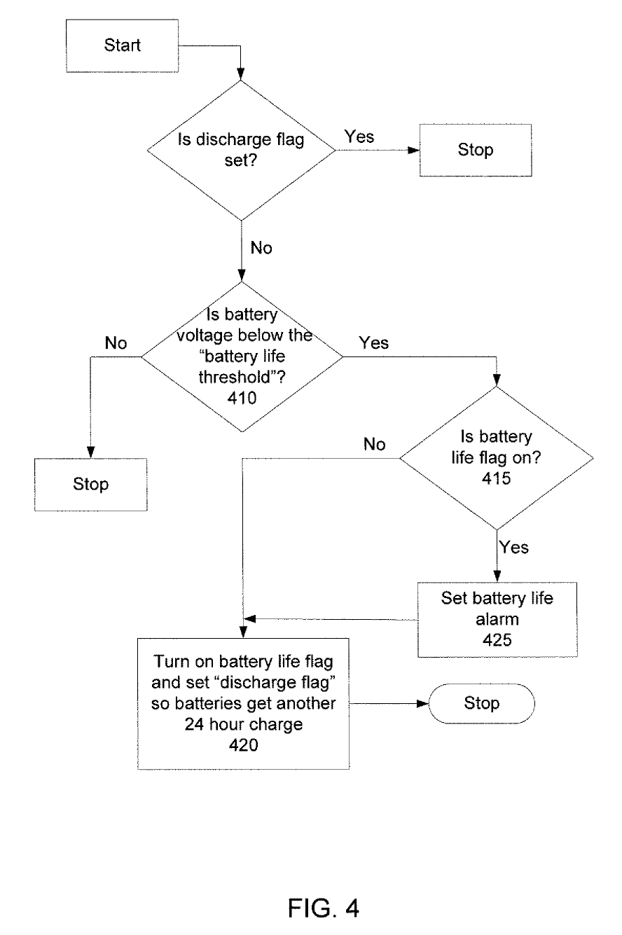

The control unit 115 may also monitor the voltage across the battery 105 to determine whether or not the battery 105 is nearing the end of its life cycle or life span, as described in greater detail below with reference to FIG. 4.

The control unit 115 may communicate a wide range of data to a user of the battery charger 105 such as the average temperature, the float charge time of a battery 105, or a battery life alarm. Data may be communicated to a user by the control unit 115 in a variety of ways including, but not limited to, through the use of a visual indicator or over the communication line 160. As an example of data that may be communicated to a user, the control unit 115 may communicate a battery life alarm to a user to indicate that a battery 105 serviced by the battery charger 105 is potentially nearing the end of its life cycle. The battery life alarm may be communicated to a user in a variety of ways. For example, a visual indicator such as an LCD display or one or more LED's may be included in the battery charger 100, and the display or LED's may be actuated in such a manner as to inform a user of the battery life alarm. As an alternative, the battery life alarm may be communicated to the user via the communications line 160. For example, the control unit 115 may transmit, a message containing the battery life alarm to a user through the communication line 160 and then over a data network such as the Internet using either a wired or wireless connection. Alternatively, the control unit 115 may transmit the message to a user through the communication line 160 and then over a power line using power line carrier or broadband over power line technology.

It will also be understood that the battery charger 100 may be incorporated into the charger power supply 110 or, alternatively, the battery charger 100 may be a separate device. As previously mentioned, the charger power supply 110 may be a power line that is used to supply an electrical charge or current to electronic equipment. If the charger power supply is a power line, the battery charger 100 may be, for example, incorporated into the power line.

FIG. 3 is an exemplary flowchart of the general operation of the control unit 115 of a battery charger 100, according to an illustrative embodiment of the present invention. After the control unit 115 receives power and the programmed control logic is implemented, the control unit begins at step 305. The control unit 115 may also go to step 305 at the start of a new monitoring time span. For example, if the monitoring time span is one day or 24 hours, then the control unit 115 will go the step 305 at the start of each new 24 hour period. Thus, the control unit 115 may go to step 305 at, for example, midnight of each new day. At step 305, the control unit 115 determines whether or not a battery 105 has been discharged by determining whether or not the discharge flag has been set. If the discharge flag for the battery 105 has been set, then the control unit 115 goes to step 310. At step 310, the control unit 115 resets the discharge flag and closes the charge relay 120 if it has not already been closed. Then, the control unit 115 goes to step 315 and allows the battery 105 to be float charged for a period of time roughly equivalent to the recharging time span which may be, for example, 24 hours. After the battery 105 has been float charged for the recharging time span, the control unit 115 stops and waits for its next beginning or start period. The next start period may occur, for example, at the beginning of the next monitoring time span when the control unit 115 reenters step 305.

If, however, at step 305, the control unit determines that the discharge flag of the battery 105 has not been set, then the control unit 115 goes to step 320. At step 320, the control unit 115 determines whether or not the current time is at the start time or within a predetermined range of the start time of the low temperature period. The predetermined range may be any preset time interval before and/or after the start time of the low temperature period such as, for example, five minutes. Accordingly, if the start time of the low temperature period is one 1:00 a.m. and the current time is 1:04 a.m., the control unit 115 may determine that the current time is within the predetermined range of the start time. Alternatively, at step 320 the control unit 115 may determine whether or not the current time is at or within a predetermined range of the charging start time. If the current time is not at or within a predetermined range of the start time of the low temperature period, then the control unit 115 goes back to step 305. If, however, at step 320, it is determined that the current time is at or within a predetermined range of the start time of the low temperature time, then the control unit 115 goes to step 330. At step 330, the control unit 115 turns on or closes the charge relay 120 and starts a timer that counts up to the predetermined length of charge time (i.e., the charging time span). The control unit 115 then goes to step 335 and determines whether the charge current is below the current set point. If, at step 335, it is determined that the current is below the current set point, then the control unit 115 goes to step 350. If, however, at step 335, it is determined that the current is not below the current set point, then the control unit 115 goes to step 340 and determines whether or not the charging time span is over. The control unit 115 may determine whether or not the charging time is over by determining whether or not the value in the timer is greater than or equal to the charging time span. Alternatively, the control unit 115 may compare the current time to the ending time of the low temperature period. If, at step 340, it is determined that the charging time span is not over, then the control unit 115 goes back to step 335. If, however, it is determined that the charging time span is over, then the control unit 115 goes to step 345. At step 345, the control unit 115 determines whether or not the charge current in the battery 105 is above the current set point. If the charge current is not above the current set point, then the control unit 115 goes to step 350. At step 350, the control unit 115 turns off or opens the charge relay 120 and ends its operation. If, however, at step 345, it is determined that the charge current is above the current set point, then the control unit 115 goes to step 355. At step 355, the control unit 115 determines whether or not the battery life flag is on. If the battery life flag is not on, then the control unit 115 goes to step 360. If, however, the battery life flag is on, then the control unit goes to step 365. At step 365, the control unit sets or turns on the battery life alarm and then goes to step 360. At step 360, the control unit 115 turns on the battery life flag and sets the battery discharge flag so that the battery 105 will be float charged for the recharging time span. Then, the control unit 115 goes to step 305, thereby allowing the battery 105 to be float charged for the recharging time span.

It will be understood by those of skill in the art that the steps performed by the control unit 115 do not necessarily have to be performed in the exact order set forth in the logic of FIG. 3, but instead may be performed in any suitable order. It also will be understood that the control unit 115 does not have to perform each step set forth in FIG. 3, but instead may conduct less than or more than all of the steps set forth in FIG. 3. For example, if the battery 105 is being float charged for a 24 hour period, as in step 310, the control unit 115 may monitor the current set point and stop the battery charge before the expiration of the 24 hour period if the charge current is below the current set point.

FIG. 4 is an exemplary flowchart of voltage monitoring performed by a battery charger 100, according to an illustrative embodiment of one aspect of the present invention. The voltage monitoring may be performed by the control unit 115 at regular intervals, such as, for example, once every two hours. Further, the voltage monitoring may be used to determine whether or not a battery 105 is nearing the end of its life cycle. Each battery 105 has a battery life threshold voltage. The battery life threshold voltage may be specified by the manufacturer of the battery 105 or, alternatively, specified by a user of the present invention. If the voltage charge held by the battery falls below the battery life threshold voltage, then the control unit 115 may determine that the battery is nearing the end of its life cycle.

Once the control unit 115 begins its voltage monitoring of a battery 105, it goes to step 405. At step 405, the control unit 115 determines whether or not the battery 105 has been discharged by determining whether or not the battery discharge flag has been set. If the battery discharge flag has been set, then the control unit 115 stops. It however, the battery discharge flag has not been set then the control unit 115 goes to step 410. At step 410, the control unit 115 determines whether or not the voltage charge in the battery 105 is below the battery life threshold. If the voltage charge is not below the battery life threshold, then the control unit 115 stops. If, however, the voltage charge is below the battery life threshold, then the control unit 115 goes to step 415. At step 415, the control unit 115 determines whether or not the battery life flag is on. If the battery life flag is not on, then the control unit 115 goes to step 420. If, however, the battery life flag is on, then the control unit goes to step 425. At step 425, the control unit sets or turns on the battery life alarm and then goes to step 420. At step 420, the control unit 115 turns on the battery life flag and sets the battery discharge flag so that the battery will be float charged for a period of time roughly equivalent to the predetermined recharging time span. The control unit 115 then stops its operation.

It will be understood by those of skill in the art that the steps performed by the control unit 115 do not necessarily have to be performed in the exact order set forth in the logic of FIG. 4, but instead may be performed in any suitable order. It also will be understood that the control unit 115 does not have to perform each step set forth in FIG. 4, but instead may conduct less than or more than all of the steps set forth in FIG. 4.

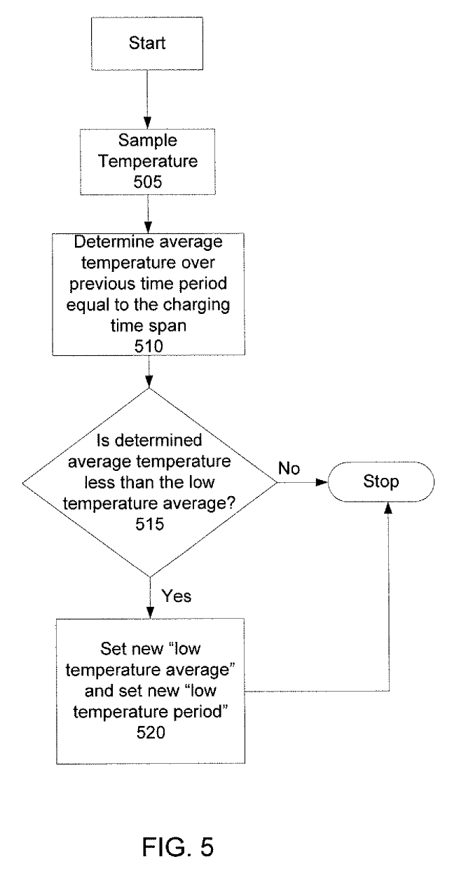

FIG. 5 is an exemplary flowchart of ambient temperature monitoring performed by a battery charger 100, according to an illustrative embodiment of one aspect of the present invention. The steps of FIG. 5 may be performed by the control unit 115 to determine the coolest period of time occurring within a monitoring time span that has a duration roughly equivalent to the charging time span. The coolest time period may then be stored as the low temperature period and utilized by the control unit 115 to determine when to float charge batteries 105 in one or more subsequent monitoring time spans. For example, the steps of FIG. 5 may be used by the control unit 115 to determine the coolest eight hour period of the current day so that the coolest eight hour period of the following day may be estimated. At step 505, the control unit 115 receives a current temperature measurement from the temperature sensor 130. Then, the control unit 115 goes to step 510. At step 510, the control unit 115 determines the average temperature over the preceding time period that is approximately equivalent in duration to the charging time span such as, for example, the average temperature over the previous eight hours. Then, the control unit 115 goes to step 515. At step 515, the control unit 115 determines whether the determined average temperature is lower than the previously stored average temperature of the low temperature period, or the low temperature average. If the new average temperature is not lower than the low temperature average, then the control unit 115 stops and waits for the next temperature measurement. If, however, at step 515, it is determined that the new average temperature is lower than the low temperature average, then the control unit 115 goes to step 520. At step 520, the control unit 115 sets the value of the low temperature average to the value of the new average temperature. The control unit 115 also sets the low temperature period to the time period over which the new average temperature was determined. Then, the control unit 115 ceases its operation.

It will be understood by those of skill in the art that the steps performed by the control unit 115 do not necessarily have to be performed in the exact order set forth in the logic of FIG. 5, but instead may be performed in any suitable order. It also will be understood that the control unit 115 does not have to perform each step set forth in FIG. 5, but instead may conduct less than or more than all of the steps set forth in FIG. 5.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A battery charger, comprising:
a relay that controls the flow of an electrical charge current from a power supply to one or more batteries;
a control unit that controls the actuation of the relay; and
a temperature sensor that continuously measures the ambient temperature of the one or more batteries and communicates the temperature measurements to the control unit;
wherein the control unit receives the temperature measurements from the temperature sensor, determines a charging time period for the one or more batteries, and selectively actuates the relay for the charging time period; and
wherein the charging time period for the one or more batteries has a predetermined duration and represents a coolest time period within a monitoring period of the control unit.

2. The battery charger of claim 1, wherein the monitoring period of the control unit is a twenty-four hour period.

3. The battery charger of claim 1, wherein the charging time period occurs at night.

4. The battery charger of claim 1, wherein the duration of the charging time period is approximately eight hours or less.

5. The battery charger of claim 1, wherein the charging time period is determined for a first monitoring period and, based on the determined charging time period, the control unit causes the one or more batteries to be charged during a second monitoring period.

6. The battery charger of claim 5, wherein the control unit determines the charging time period by calculating a running average of the ambient temperature over the first monitoring period and determining a lowest temperature time period occurring in the first monitoring period that has a lowest average ambient temperature over the duration of the lowest temperature time period;
wherein the duration of the lowest temperature time period is the same as the duration of the charging time period.

7. The battery charger of claim 1, wherein the one or more batteries comprise multiple strings of batteries, and wherein the control unit charges the multiple strings of batteries in a rotational order.

8. The battery charger of claim 1, further comprising:
a current sensor that measures the current of the electrical charge being supplied to the one or more batteries and communicates the current measurements to the control unit;
wherein the battery charger does not charge the one or more batteries if the detected current is below a current set point.

9. The battery charger of claim 8, wherein the current set point is approximately 0.003 multiplied by a 20 hour rated capacity of the one or more batteries.

10. The battery charger of claim 1, wherein the battery charger is incorporated into a power cable that is disposed between the power supply and the one or more batteries and wherein the power cable is configured to supply the electrical charge current to the one or more batteries.

11. An automatic system for float charging one or more batteries, comprising:
a power supply configured to output an electrical charge current that is used to charge one or more batteries;
a relay that controls the flow of the electrical charge current from the power supply to the one or more batteries;
a temperature sensor that continuously measures the ambient temperature of the one or more batteries; and
a control unit configured to:
receive the temperature measurements from the temperature sensor;
determine a time period for charging the one or more batteries; and
selectively actuate the relay for the time period for charging the one or more batteries;
wherein the time period for charging the one or more batteries has a predetermined duration and represents a coolest time period within a monitoring period of the control unit;

12. The system of claim 11, wherein the time period for charging is determined for a first monitoring period and, based on the determined time period for charging, the control unit causes the one or more batteries to be charged during a second monitoring period.

13. The system of claim 12, wherein the control unit determines the time period for charging by calculating a running average of the ambient temperature over the first monitoring period and determining a lowest temperature time period occurring in the first monitoring period that has a lowest average ambient temperature over the duration of the lowest temperature time period;
wherein the duration of the lowest temperature time period is the same as the duration of the time period for charging.

14. A method for float charging one or more batteries, comprising:
monitoring the ambient temperature of the one or more batteries over a first monitoring period;
determining a charging period having a predetermined charging duration that represents a coolest time period having the predetermined charging duration that occurs within the first monitoring period; and
charging the one or more batteries during the charging period in a second monitoring period;

15. The method of claim 14, wherein the duration of the first monitoring period and the duration of the second monitoring period is approximately twenty-four hours.

16. The method of claim 14, wherein the predetermined charging duration of the charging period is approximately eight hours or less.

17. The method of claim 14, wherein determining the charging period comprising calculating a running average of the ambient temperature over the first monitoring period and determining a lowest temperature time period occurring in the first monitoring period that has a lowest average ambient temperature over the duration of the lowest temperature time period;
wherein the duration of the lowest temperature time period is the same as the duration of the charging period.

18. The method of claim 14, wherein the one or more batteries comprise multiple strings of batteries, and wherein the control unit charges the multiple strings of batteries in a rotational order.

19. The method of claim 14, further comprising:
monitoring a current of an electrical charge being supplied to the one or more batteries during the charging of the batteries; and
stopping the charging if the current is below a current set point.

20. The method of claim 19, wherein the current set point is approximately 0.003 multiplied by a 20 hour rated capacity of the one or more batteries.
